(19) United States
(12) Patent Application Publication
(10) Pub. No.: US 2018/0328650 A1
(43) Pub. Date: Nov. 15, 2018

(54) TURNABLE PARTITION MEMBER AND REFRIGERATOR

(71) Applicant: PANASONIC CORPORATION, Osaka (JP)

(72) Inventors: Toru OKAZAKI, Osaka (JP); Terutsugu SEGAWA, Osaka (JP); Yasuhiro ASAIDA, Kyoto (JP)

(21) Appl. No.: 15/975,562

(22) Filed: May 9, 2018

(30) Foreign Application Priority Data
May 10, 2017 (JP) 2017-093809

(51) Int. Cl. F25D 23/08; F25D 23/02; E05C 19/16

(52) U.S. Cl. CPC F25D 23/087; F25D 23/028; F25D 2600/04; F25D 2201/126; E05C 19/161

(57) ABSTRACT

Turnable partition member and refrigerator according to the present disclosure include housing, heat insulator provided in housing, and releasing sheet provided between housing and heat insulator. With releasing sheet provided between housing and heat insulator, housing is not pulled by heat insulator at the time of curing and shrinking heat insulator, and the warp of the entirety of turnable partition member can be suppressed without using thick reinforcement plate. The present disclosure thus provides turnable partition member that can suppress the warp without reducing the heat insulating property.

### CROSS REFERENCE TO RELATED APPLICATIONS

This application is entitled to and claims the benefit of Japanese Patent Application No. 2017-093809, filed on May 10, 2017, the disclosure of which including the specification, drawings and abstract is incorporated herein by reference in its entirety.

### TECHNICAL FIELD

The present disclosure relates to a turnable partition member that is attached to left and right storage compartment doors for opening and closing the front opening of a storage compartment of a refrigerator, and makes intimate contact with free end portions of the storage compartment doors when the storage compartment is in a closed state to thereby increase the sealing performance at the free end portions, for example. The present disclosure also relates to a refrigerator including the turnable partition member.

### BACKGROUND ART

PTL 1 and so forth disclose a refrigerator including left and right storage compartment doors (first and second turning doors) that open and close the front opening of a storage compartment, for example. As disclosed in PTL 1, in such a refrigerator, a vertically elongated turnable partition member (hereinafter referred to as “turnable partition member”) is attached on a rear surface of one turning door on a side (free end side) opposite to the turning axis side. When the one turning door is closed, the turnable partition member turns to connect between the free end portions of the two turning doors. In the state where the two turning doors are closed, the turnable partition member and the gaskets provided in the first and second turning doors make intimate contact with each other, and thus leakage of the cold air in the storage compartment is prevented.

The turnable partition member is configured with a heat insulator such as urethane foam provided in a housing made of a synthetic resin. An iron plate or a Magnet for magnetically adhering to the gaskets provided in the first and second turning doors is provided on the front side of the heat insulator. That is, gaskets, each of which is provided with a magnet or an iron plate, are provided on the rear surfaces of the free end portions of the first and second turning doors, and the turnable partition member and the first and second turning doors can magnetically make intimate contact with each other so as to increase the sealing performance at the free end portions.

### CITATION LIST

### Patent Literature

### PTL 1

### Japanese Patent Application Laid-Open No. 2015-175584

### SUMMARY OF INVENTION

### Technical Problem

In the case where urethane foam or the like is used as the heat insulator of the turnable partition member as described above, the heat insulator adheres to the wall surface of the housing of the turnable partition member and is cured at the time of injecting and curing the heat insulator, and thereafter the entire heat insulator is cured. Consequently, a tensile stress resulting from curing shrinkage of the heat insulator acts on the housing of the turnable partition member, and the vertically long turnable partition member is disadvantageously warped. To suppress the warp of turnable partition member, it is conceivable to increase the thickness of a metal reinforcement plate disposed in the turnable partition member.

However, when the thickness of a metal reinforcement plate having a low heat insulating property is increased, the heat insulating property of the turnable partition member is disadvantageously reduced in its entirety.

An object of the present disclosure is to provide a turnable partition member that can suppress the warp without reducing the heat insulating property, and a refrigerator including such a turnable partition member.

### Solution to Problem

To achieve the above-mentioned object, a turnable partition member of the present disclosure includes: a housing; a heat insulator that is provided in the housing; and a releasing sheet provided between the housing and the heat insulator.

In addition, a refrigerator of the present disclosure includes the turnable partition member.

### Advantageous Effects of Invention

In the present disclosure, a releasing sheet is provided between the housing and the heat insulator, and therefore the housing is not pulled by the heat insulator at the time of curing and shrinking the heat insulator. Accordingly, it is possible to suppress the warp of the turnable partition member without using a thick reinforcement plate. In this manner, it is possible to provide a turnable partition member that can suppress the warp without reducing the heat insulating property.

### BRIEF DESCRIPTION OF DRAWINGS

FIG. 1 is a perspective view illustrating an external configuration of a refrigerator including a turnable partition member according to the embodiment;

FIG. 2 illustrates a refrigerator as viewed from an upper side with first and second turning doors opened;

FIG. 3 illustrates the refrigerator as viewed from an upper side with the first and second turning doors closed;

FIG. 4 is a perspective view illustrating an external configuration of a turnable partition member,

FIG. 5 is a sectional view taken along line A-A′ of FIG. 4;

FIG. 6 illustrates a state where a releasing sheet is provided at or near both ends of the turnable partition member in the longitudinal direction; and

FIG. 7 is illustrates a state where a releasing sheet is provided at or near a center the turnable partition member in the longitudinal direction.

### DESCRIPTION OF EMBODIMENTS

An embodiment of the present disclosure is elaborated below with reference to the accompanying drawings.

### 1 Embodiment

### <1-1>General Configuration of Refrigerator

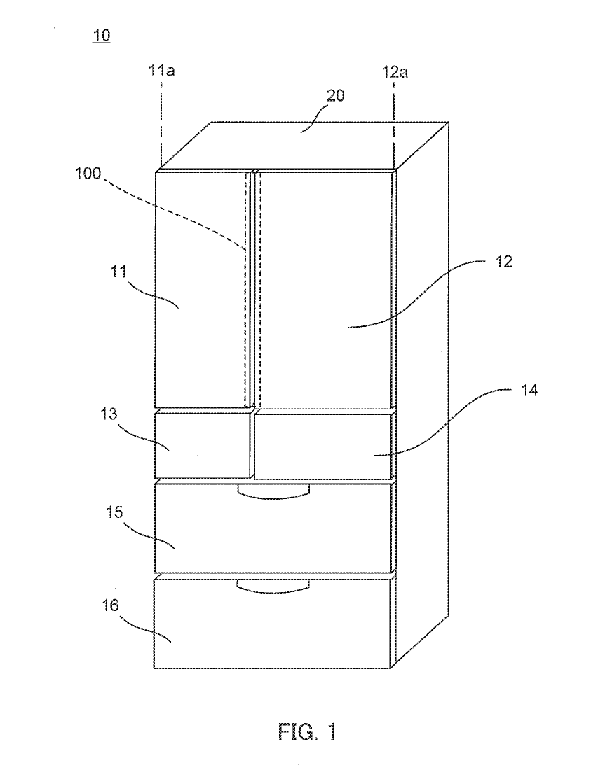

FIG. 1 is a perspective view illustrating an external configuration of refrigerator 10 including turnable partition member 100 of the present embodiment. Refrigerator 10 includes first and second turning doors 11 and 12 which are provided on the front surface of the refrigerating compartment. First and second turning doors 11 and 12 are turnable around turning axes 11a and 12a, respectively, which are indicated with the virtual lines, and thus can serve as so-called double-doors.

A plurality of drawer-type doors are provided on the lower side of first and second turning doors 11 and 12. Namely, ice compartment door 13, upper freezing compartment door 14, lower freezing compartment door 15 and vegetable compartment door 16 are provided.

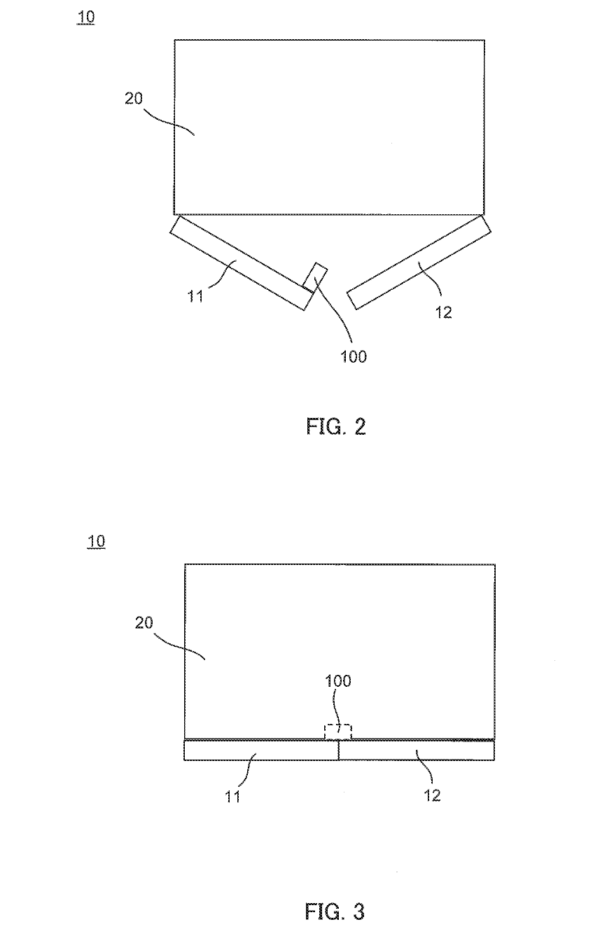

FIG. 2 illustrates refrigerator 10 as viewed from the upper side with first and second turning doors 11 and 12 opened. As can be seen from FIG. 2, tamable partition member 100 is attached on the rear surface of the free end portion of first turning door 11. Turnable partition member 100 has a vertically long cuboid shape that vertically extends over the entirety of the free end portion of first turning door 11. When first turning door 11 is closed, turnable partition member 100 makes contact with a protrusion (not illustrated) provided in refrigerator main body 20, thus turning 90 degrees. As a result, turnable partition member 100 is placed at a position where turnable partition member 100 makes contact with the free end portions of first and second turning doors 11 and 12 so as to connect therebetween.

FIG. 3 illustrates refrigerator 10 as viewed from the upper side with first and second turning doors 11 and 12 closed. As can be seen from FIG. 3, turnable partition member 100 makes contact with the free end portions of first and second turning doors 11 and 12. Specifically, when first and second turning doors 11 and 12 are closed, turnable partition member 100 and gaskets provided at the free end portions of first and second turning doors 11 and 12 make intimate contact with each other, whereby the sealing performance at the free end portions is increased and leakage of the cold air in the refrigerating compartment is prevented.

It is to be noted that the intimate contact with the gasket and the turning operation of turnable partition member 100 are disclosed in PTL 1 and so forth, and therefore the detailed description thereof is omitted.

### <1-2>Configuration of Turnable Partition Member

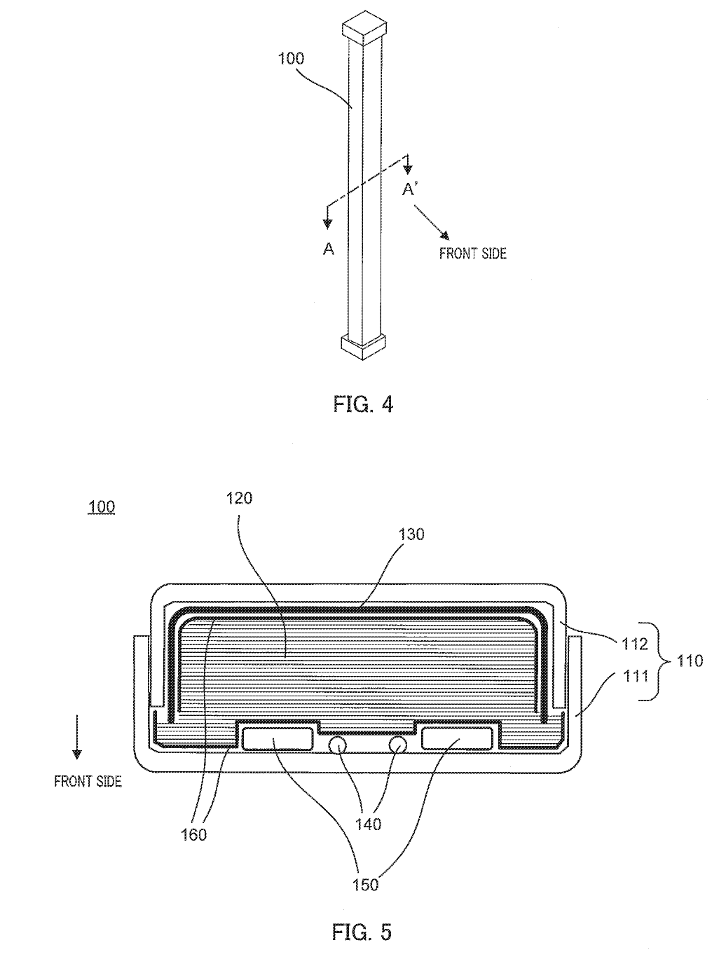

FIG. 4 is a perspective view illustrating an external configuration of turnable partition member 100, and FIG. 5 is a sectional view taken along line A-A′ of FIG. 4.

Turnable partition member 100 includes housing 110, and the interior of housing 110 is filled with heat insulator 120. Housing 110 includes front plate 111 that forms the front surface part and makes contact with the gaskets provided in first and second turning doors 11 and 12, and rear plate 112 joined to front plate 111. Housing 110 is formed of a synthetic resin, for example.

Heat insulator 120 is urethane foam. The urethane foam of heat insulator 120 is injected into housing 110 from a predetermined inlet of housing 110. It is to be noted that heat insulator 120 is not limited to urethane foam, and may be any foam as long as heat insulator 120 can be cured in housing 110.

In addition, reinforcement plate 130 is provided in housing 110. Reinforcement plate 130 of the present embodiment has a U-shape in cross section, and is provided next to rear plate 112. Reinforcement plate 130 longitudinally (i.e. vertically) extends over the entirety of turnable partition member 100, and prevents deformation of turnable partition member 100. Reinforcement plate 130 is configured to prevent the warp and the like of turnable partition member 100 in a direction perpendicular to the longitudinal direction in particular. Reinforcement plate 130 is formed of a metal such as iron, for example.

Heater 140 is provided on the back side of front plate 111. Heater 140 is a heat wire that longitudinally (i.e. vertically) extends over the entirety of turnable partition member 100, and prevents condensation from being generated on front plate 111 by heating front plate 111.

In addition, magnet 150 is provided on the back side of front plate 111. Magnet 150 longitudinally (i.e. vertically) extends over the entirety of turnable partition member 100, and increases the adhesion between turnable partition member 100 and first and second turning doors 11 and 12 by being magnetically attracted by a metal such as iron and/or a magnet provided in the gaskets of first and second turning doors 11 and 12. It is to be noted that in the case where a magnet is provided in the gaskets of first and second turning doors 11 and 12, a metal such as iron may be provided in place of magnet 150.

In addition to the above-mentioned configuration, turnable partition member 100 of the present embodiment is provided with releasing sheet 160. Releasing sheet 160 is provided between heat insulator 120 and housing 110. In addition, releasing sheet 160 is provided between heat insulator 120 and reinforcement plate 130. Releasing sheet 160 longitudinally (i.e. vertically) extends over the entirety of turnable partition member 100.

This configuration can prevent heat insulator 120 from adhering (or being bonded) to housing 110 and reinforcement plate 130, and thus can suppress the warp of housing 110 and/or reinforcement plate 130 at the time of curing heat insulator 120. As a result, in the case where reinforcement plate 130 is used as in the present embodiment, the thickness of reinforcement plate 130 can be reduced, and reduction in heat insulating property can accordingly be suppressed.

Releasing sheet 160 may be firmly fixed to housing 110 and reinforcement plate 130, or may not be firmly fixed to housing 110 or reinforcement plate 130. It is preferable to firmly fix releasing sheet 160 to housing 110 and reinforcement plate 130 since, in such a configuration, no gap is formed between releasing sheet 160, and housing 110 and reinforcement plate 130. In the case where releasing sheet 160 is firmly fixed to housing 110 and reinforcement plate 130 and the like, it is desirable that releasing sheet 160 be formed of a material whose releasing property with respect to heat insulator 120 is higher than that of housing 110 and/or reinforcement plate 130. In this manner, a large gap is not formed between heat insulator 120, and housing 110 and/or reinforcement plate 130, and, the warp of housing 110 and/or reinforcement plate 130 due to the tensile stress at the time of curing heat insulator 120 can be suppressed.

In addition, preferably, releasing sheet 160 has a high heat insulating property in addition to the releasing property. In practice, it is preferable to select, as releasing sheet 160, a material having a heat insulating property higher than that of housing 110 and/or reinforcement plate 130.

In the present embodiment, releasing sheet 160 is formed of a combination of heat insulating beads and a fiber structure such as an aerogel non-woven fabric composite heat insulator. It is preferable to use a highly water-repellent material such as silica for the heat insulating beads. That is, releasing sheet 160 of the present embodiment provides the strength of a fiber structure such as a non-woven fabric while achieving the heat insulating property and the releasing property of heat insulating beads and/or aerogel. By using the above-mentioned materials, releasing sheet 160 can have a releasing property and a heat insulating property.

### <1-3>Effect

As described above, in the present embodiment, turnable partition member 100 is provided with releasing sheet 160 so that heat insulator 120 does not adhere to housing 110 and/or reinforcement plate 130, and therefore, housing 110 and/or reinforcement plate 130 are not pulled by heat insulator 120 at the time of curing shrinkage of heat insulator 120. The warp of turnable partition member 100 can thus be suppressed.

### Other Embodiments

While the invention made by the present inventor has been specifically described based on the preferred embodiments, it is not intended to limit the present invention to the above-mentioned preferred embodiments but the present invention may be further modified within the scope and spirit of the invention defined by the appended claims.

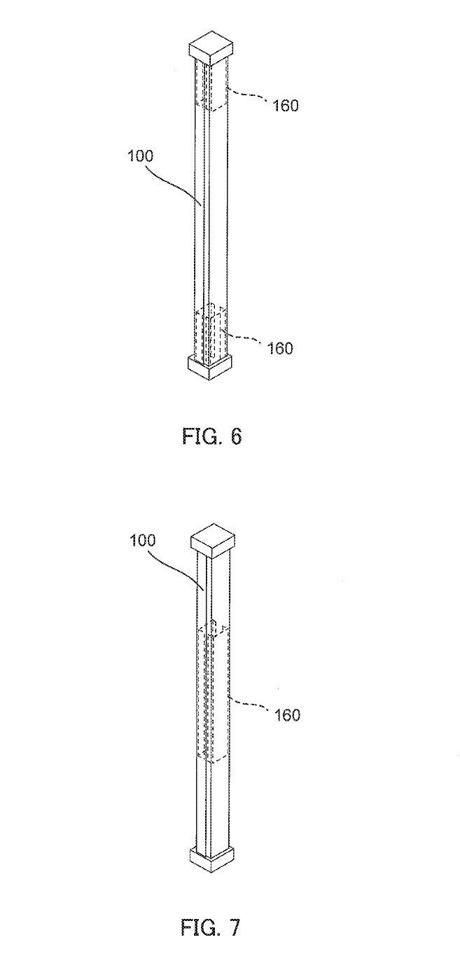

While releasing sheet 160 longitudinally (i.e. vertically) extends over the entirety of turnable partition member 100 in the embodiment, releasing sheet 160 may be provided only at both end portions of turnable partition member 100 (in other words, housing 110) in the longitudinal direction as illustrated in FIG. 6. In addition, as illustrated in FIG. 7, releasing sheet 160 may be provided only at a center portion of turnable partition member 100 (in other words, housing 110) in the longitudinal direction. With such configurations, the amount of releasing sheet 160, which is an expensive member, can be reduced, and thus the cost can be reduced in comparison with the case where releasing sheet 160 longitudinally extends over the entirety of turnable partition member 100.

In practice, when heat insulator 120 composed of urethane foam or the like is injected into housing 110, heat insulator 120 can be injected from a center portion of turnable partition member 100 in the longitudinal direction, or from both ends of turnable partition member 100 in the longitudinal direction. When urethane is injected from a center portion, the density of the foam is stable because of vertical foaming of the urethane. It should be noted that, particularly when the urethane is foamed and cured, a pressure is exerted on the both end portions and consequently deformation easily occurs. In view of this, in the case where heat insulator 120 composed of urethane foam or the like is injected from a center portion of turnable partition member 100 in the longitudinal direction, it is preferable to provide releasing sheet 160 at or near the both ends in the longitudinal direction as illustrated in FIG. 6. With this configuration, the urethane resin does not tend to retain at the both end portions, whereby the pressure can be dispersed, and deformation of housing 110 and/or reinforcement plate 130 can be suppressed. In the case where heat insulator 120 composed of the urethane foam or the like is injected from the both ends of turnable partition member 100 in the longitudinal direction, a pressure is exerted particularly on a center portion when the urethane is foamed and cured, and consequently deformation easily occurs. In view of this, in the case where heat insulator 120 composed of the urethane foam or the like is injected from the both ends of turnable partition member 100 in the longitudinal direction, it is preferable to provide releasing sheet 160 at or near the center in the longitudinal direction as illustrated in FIG. 7.

While reinforcement plate 130 is formed of a metal such as iron in the embodiment, reinforcement plate 130 may be formed of a resin impregnated with cellulose nanofiber. With such a configuration, the heat insulating property of reinforcement plate 130 can be increased. Likewise, by forming housing 110 with a resin impregnated with cellulose nanofiber, the heat insulating property of housing 110 can be increased. It is to be noted that both front plate 111 and rear plate 112 may be formed of a resin impregnated with cellulose nanofiber, or, only one of front plate 111 and rear plate 112 may be formed of a resin impregnated with cellulose nanofiber. In addition, when housing 110 and/or reinforcement plate 130 is formed of a resin impregnated with cellulose nanofiber, the weight of turnable partition member 100 can be reduced, and accordingly, the ease of the turning operation of turning door 11 by a user is increased.

While reinforcement plate 130 is used in the embodiment, reinforcement plate 130 may be omitted when housing 110 itself can provide a desired strength.

In addition, releasing sheet 160 may be a releasing film. In the present disclosure, the releasing sheet may have a sheet form or a film form.

Further, turnable partition member 100 of the embodiment is applicable not only to a refrigerator, but also to various thermal insulation units. That is, turnable partition member 100 of the embodiment is suitable also as a turnable partition member that is attached to free end portions of first and second turning doors of a thermal insulation unit, and makes intimate contact with the free end portions of the first and second turning doors to thereby increase the sealing performance at the free end portions when the first and second turning doors are closed. It is to be noted that heater 140 may be omitted in the case where the turnable partition member is used in equipment other than refrigerators. In addition, magnet 150 may be omitted.

The turnable partition member of the embodiment is suitable for cases where a heat insulator that generates a tensile stress on the housing at the time of curing.

It is to be noted that the embodiments may appropriately be combined.

### INDUSTRIAL APPLICABILITY

The turnable partition member according to the present disclosure is useful as a turnable partition member that is attached to a hearing unit such as a refrigerator.

### REFERENCE SIGNS LIST

10 Refrigerator
11 First turning door
12 Second turning door
20 Refrigerator main body
100 Turnable partition member
110 Housing
111 Front plate
112 Rear plate
120 Heat insulator
130 Reinforcement plate
140 Heater
150 Magnet
160 Releasing sheet

1. A turnable partition member comprising:
a housing;
a heat insulator that is provided in the housing; and
a releasing sheet provided between the housing and the heat insulator.

2. The turnable partition member according to claim 1 further comprising a reinforcement plate provided in the housing, wherein
the releasing sheet is provided between the reinforcement plate and the heat insulator.

3. The turnable partition member according to claim 1, wherein the releasing sheet is provided between the housing and the heat insulator.

4. The turnable partition member according to claim 1, wherein a releasing property of the releasing sheet with respect to the heat insulator is higher than a releasing property of the housing with respect to the heat insulator.

5. The turnable partition member according to claim 2, wherein a releasing property of the releasing sheet with respect to the heat insulator is higher than a releasing property of the reinforcement plate with respect to the heat insulator.

6. The turnable partition member according to claim 1, wherein the releasing sheet has an insulating property higher than an insulating property of the housing.

7. The turnable partition member according to claim 2, wherein the releasing sheet has a heat insulating property higher than a heat insulating property of the reinforcement plate.

8. The turnable partition member according to claim 1, wherein the releasing sheet is formed of a combination of heat insulating beads and a fiber structure.

9. The turnable partition member according to claim 1, wherein the releasing sheet is an aerogel non-woven fabric composite heat insulator.

10. The turnable partition member according to claim 8, wherein the heat insulating beads are silica.

11. The turnable partition member according to claim 2, wherein the reinforcement plate is a resin impregnated with cellulose nanofiber.

12. The turnable partition member according to claim 1, wherein at least a part of the housing is a resin impregnated with cellulose nanofiber.

13. The turnable partition member according to claim 1, wherein the releasing sheet is provided at both end portions of the housing in a longitudinal direction.

14. The turnable partition member according to claim 1, wherein the releasing sheet is provided at a center portion of the housing in a longitudinal direction.

15. A refrigerator comprising the turnable partition member according to claim 1.

16. A refrigerator wherein:
the turnable partition member according to claim 1 is attached to free end portions of a first turning door and a second turning door of the refrigerator; and
when the first turning door and the second turning door are closed, the turnable partition member makes intimate contact with the free end portions of the first turning door and the second turning door.
